(19) United States
(12) Patent Application Publication
(10) Pub. No.: US 2009/0134320 A1
(43) Pub. Date: May 28, 2009

(54) FILTERED PHOTOSENSORS AND PHOTO CONTROL DEVICES INCLUDING THE SAME AND METHODS FOR FORMING THE SAME

(76) Inventor: Richard Charles Flaherty, Fuquay Varina, NC (US)

Correspondence Address: Marguerite E. Gerstner;Tyco Electronics Corporation - IP Law Dept., M/S R34/2B, 309 Constitution Drive, Menlo Park, CA, 94025-1164, US

(21) Appl. No.: 12/014,423

(22) Filed: Jan. 15, 2008

Related U.S. Application Data
(60) Provisional application No. 61/004,369, filed on Nov. 27, 2007.

(51) Int. Cl. H01J 40/14; B05D 5/00

(52) U.S. Cl. 250/239; 427/160

(57) ABSTRACT

Methods of forming a filtered photosensor include providing a photosensor and an infrared blocking ink. The infrared blocking ink is printed on the photosensor. Printing the infrared blocking ink may include dipping the photosensor in the infrared blocking ink or spraying and/or brushing the infrared blocking ink on the photosensor. Photo control devices including a photosensor with an infrared blocking ink thereon are also provided.

### RELATED APPLICATIONS

The present application claims priority from U.S. Provisional Application No. 61/004,369 (Attorney Docket No. E-EN-00089-US/5487-271PR), filed Nov. 27, 2007, the disclosure of which is hereby incorporated herein in its entirety by reference.

### BACKGROUND OF THE INVENTION

The present invention relates to photo control devices and, more particularly, photo control devices for use in infrared electromagnetic radiation sensitive applications.

Photosensors used in photo control devices are generally sensitive to infrared (IR) electromagnetic radiation (light) that the human eye cannot generally detect. Thus, photo controls manufactured with such photosensors may be sensitive to infrared electromagnetic radiation and the presence of infrared electromagnetic radiation may cause undesired operation of a photo control. For example, a photo control may activate to switch off street lighting even though a human would perceive a lack of light. In conventional photo controls for such applications, an infrared blocking filter may be used that is a separate component, typically in the form of a sheet of filtering material that would mechanically fasten between the photosensor and a light receiving window of the photosensor.

### SUMMARY OF THE INVENTION

Embodiments of the present invention provide methods of forming a filtered photosensor including providing a photosensor and an infrared blocking ink. The infrared blocking ink is printed on the photosensor. For example, printing the infrared blocking ink may include dipping the photosensor in the infrared blocking ink or spraying and/or brushing the infrared blocking ink on the photosensor.

In other embodiments, the photosensor includes a body having a lead extending therefrom and dipping the photosensor in the infrared blocking ink includes gripping the photosensor by the lead and dipping the body of the photosensor in the infrared blocking ink while gripping the lead to retain the photosensor. The photosensor may be a photodiode. The photosensor may be a surface mount photosensor and printing the infrared blocking ink may include spraying the infrared blocking ink on the surface mount photosensor.

In further embodiments, methods of fabricating a photo control device including a filtered photosensor include providing a photosensor and an infrared blocking ink. The infrared blocking ink is printed on the photosensor. The printed photosensor is mounted on a circuit board. The circuit board, including the photosensor, is positioned in a housing of the photo control device with the photosensor positioned to receive light passing through the housing. The circuit board further includes a relay that is activated by the photosensor.

In other embodiments, positioning the circuit board including the photosensor in a housing of the photo control device is followed by mounting the photo control device to a lighting fixture. The photo control device is electrically coupled to a light source of the lighting fixture to control activation of the light source response a level of light detected by the photosensor.

In yet further embodiments, photo control devices are provided including a housing including a light transmissive portion. A photosensor is positioned in the housing to receive light passing through the light transmissive portion of the housing. An infrared blocking coating on the photosensor limits sensitivity of the photosensor to infrared electromagnetic radiation. A relay electrically coupled to the photosensor is responsive to a level of light detected by the photosensor. The infrared blocking coating may be an infrared absorbing ink and the photosensor may be a phototransistor.

In other embodiments, the light transmissive portion is a window in the housing. The photo control device further includes a circuit board mounted in the housing and the phototransistor and the relay are mounted on the circuit board. The photo control device may be a street lighting photo control device and the relay may be configured to activate to switch off street lighting responsive to detection of light by the phototransistor.

### BRIEF DESCRIPTION OF THE DRAWINGS

FIG. 1 is a schematic illustration of a filtered photosensor and apparatus and method for forming the same according to some embodiments of the present invention;

FIG. 2 is a perspective view illustrating a photo control device according to some embodiments of the present invention;

FIG. 3 is a flowchart illustrating operations for forming a filtered photosensor according to some embodiments of the present invention; and

FIG. 4 is a flowchart illustrating operations for fabricating a photo control device according to some embodiments of the present invention.

### DETAILED DESCRIPTION OF EMBODIMENTS OF THE INVENTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90° or at other orientations) and the spatially relative descriptors used herein interpreted accordingly.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

In some embodiments of the present invention as describe herein, a coated photosensor is provided for use in a photo control device so that a separate infrared blocking filter may not be needed. Methods according to some embodiments of the present invention manufacture such a photosensor by dipping a photosensor, such as a phototransistor, into an infrared (IR) absorbing ink. Such an approach may use very little material, which may reduce material costs. The dipping process itself may also be very inexpensive and may allow the use of relatively simple and reliable equipment. Furthermore, dipping may avoid some manufacturing difficulties that may arise using brushing given the typically small size of a photosensor. In addition, the resultant photosensor product may occupy very little space, compared to a separate filter design, and avoid the need for mounting devices. This may make it possible to implement IR blocking in conventional photo control device design with very little redesign to the photo control device to allow use of a dipped photo sensor.

While the use of a dipping process may be advantageous in some embodiments of the present invention, the application of the IR absorbing ink to the surface of the photosensor may more generally be referred to as printing. The IR absorbing ink could also be applied by various other printing methods, such as spraying, inkjet, silk screen, impression, rubber stamp, brushing, penning and/or the like. However, for the typically uneven surface area of a photosensor, in some embodiments, spraying, brushing and/or dipping are used to manufacture the IR absorbing ink coated photosensor.

In some embodiments, IR absorbing ink coated surface mount photosensors are provided by spraying, which may allow simpler processing as surface mount photosensors generally do not have leads, which leads may advantageously be used for handling in embodiments of the present invention where dipping is used to form the coated photosensor as the leads need not be coated as they are not a light receiving region. Such leads may, therefore, provide for convenient handling in some embodiments of the methods using dipping to coat the photosensor.

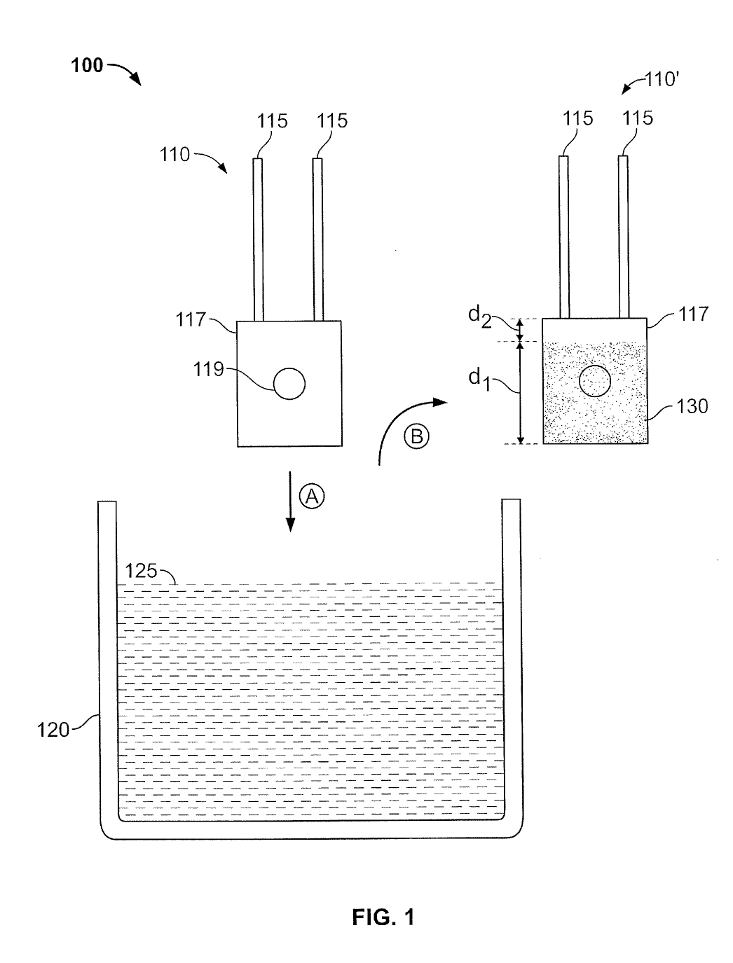

Embodiments of the present invention will now be described with reference to FIGS. 1-4. Referring to the schematic illustration of FIG. 1, a filtered photosensor for use in a photo controlled device and a method for forming the same according to some embodiments of the present invention will now be described. As shown schematically for the printing apparatus 100 of FIG. 1, a photosensor 110 is dipped in a direction A into a container 120 holding an infrared blocking ink 125. The photosensor 110 includes a body 117 having a pair of leads 115 extending from one side thereof. In addition, a photo reception window 119 is shown in the body 117 through which light is transmitted for detection by a photo detection device in the body 117.

As seen in FIG. 1, the leads 115 may be gripped and used to dip the photosensor 110 into the ink 125 so as to cover at least a portion of the body 117 including the photoreception window 119 with the infrared blocking ink 125. The photosensor 110 may then be removed as indicated by the arrow B.

The coated photosensor is also shown in FIG. 1 by reference as a photosensor 110′. As shown in FIG. 1, an infrared blocking coating 130 on the body 117 of the photosensor 110′ extends up a length d₁ of the body 117 so as to cover the window 119 and provide a photosensor 110′ that limits sensitivity of the photosensor 110′ to infrared electromagnetic radiation. The leads 115 and the length d₂ of the body 117 are shown as remaining uncoated. It may be desirable to maintain the leads 115 uncoated to facilitate formation of proper electrical connections thereto.

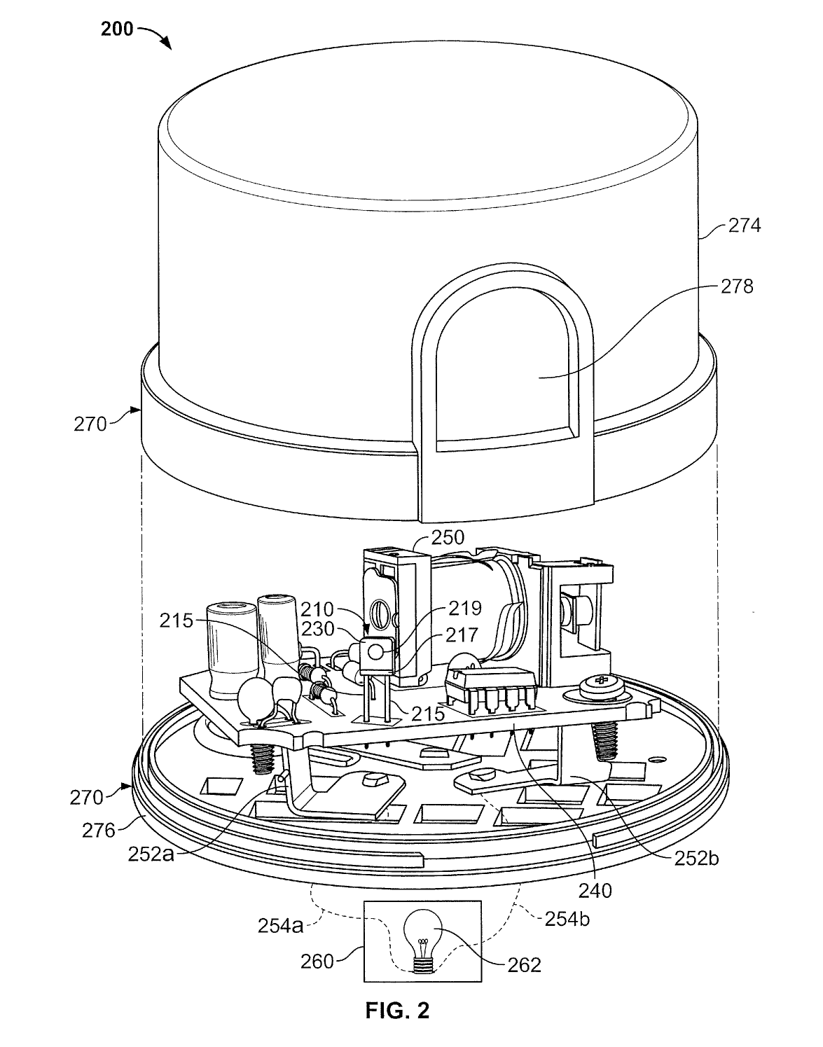

A photo control device 200 according to some embodiments of the present invention will now be described with reference to the exploded perspective view of FIG. 2. An example of a photo control device in which a coated photosensor as described herein may be used, according to some embodiments of the present invention, is the 6000 Series photo control products available from Tyco Electronics Corporation of Fuquay-Varina, N.C. As shown in the embodiments of FIG. 2, the photo control device 200 includes a photosensor 210, a relay 250 and a circuit board 240 mounted in a housing 270. The photosensor is shown as a phototransistor 210 having a pair of leads 215 extending therefrom to mount and electrically connect the phototransistor 210 to the circuit board 240. The relay 250 is similarly mounted on the circuit board 240 and is electrically coupled to the phototransistor 210 so as to be activated responsive to a level of light detected by the phototransistor 210. For example, in some embodiments, the photo control device 200 is a street lighting photo control device and the relay 250 is configured to activate to switch off street lighting responsive to detection of light by the phototransistor 210. An infrared blocking coating 230 on the phototransistor 210 limits sensitivity of the photosensor to infrared electromagnetic radiation as it covers a light receiving window 219 in the phototransistor 210.

The illustrated housing 270 includes a base 276 and a cover 274. A light transmissive window 278 is provided in the cover 274. However, it will be understood that, in some embodiments, the entirety of the cover 274 may be made from a light transmissive material rather than only providing a window 278 of light transmissive material. The phototransistor 210 is positioned in the housing 270 to receive light passing through the light transmissive window 278. As described with reference to FIG. 1, the infrared blocking coating 230 may be an infrared absorbing ink, which may be placed on the phototransistor 210 by dipping and/or other printing method.

Also shown in the embodiments of FIG. 2 are an outdoor lighting fixture 260 including a light source 262 therein. The phototransistor 210 and relay 250 are illustrated as electrically coupled through leads 252A, 252B inside the housing 270 that provide both mechanical mounting of the circuit board 240 within the housing and an electrical transmission path to external of the housing 270. Also shown schematically in FIG. 2 are electrical connections 254A, 254B from the photo control device 200 to the outdoor lighting fixture 260. In some embodiments of the present invention, known configurations and methods of control of an outdoor lighting fixture 260 using a photo control device may be used for coupling the inventive photo control device 200 to the conventional outdoor lighting fixture 260. As such, for the embodiments illustrated in FIG. 2, activation of the light source 262 may be controlled responsive to a level of light detected by the coated phototransistor 210. Note that, while the lighting fixture 260 has been referred to herein as an outdoor lighting fixture, the present invention is not limited to outdoor applications of the photo control device 200. However, in such outdoor applications, the interface between the cover 274 and base 276 of the housing 270 may be environmentally sealed in some embodiments of the present invention.

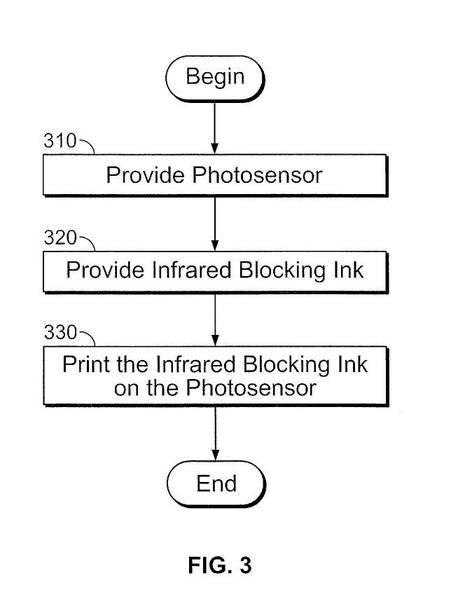

A method of forming a filtered photosensor according to some embodiments of the present invention will now be described with reference to the flowchart illustration of FIG. 3. As shown in the embodiments of FIG. 3, operations begin by providing a photosensor (block 310). For example, the photosensor may be a phototransistor 210 as described with reference to FIG. 2 above. However, it will be understood that the photosensor may be another type of photosensor including surface mount surface sensors not including leads extending therefrom. It will be further understood that a surface mount photosensor may likewise be provided as a phototransistor.

An infrared blocking ink is also provided (block 320). An example of an infrared (IR) absorbing ink that may be provided at block 320 includes the Epolight™ 8316 Ink available from Epolin, Inc. of Newark, N.J. An example of a photosensor that may be coated with such an IR absorbing ink includes the LTR-309-R, available from Lite-On Electronics, Inc., a corporation having a U.S. office in Milpitas, Calif.

The infrared blocking ink is printed on the photosensor (block 330). For example, the infrared blocking ink may be coated on the sensor by dipping the photosensor in the infrared blocking ink as described with reference to FIG. 1. In further embodiments, the infrared blocking ink may be sprayed and/or brushed on the photosensor. Such an approach may be desirable where used with surface mount photosensors lacking leads that may be conveniently gripped for use in dipping the photo sensor.

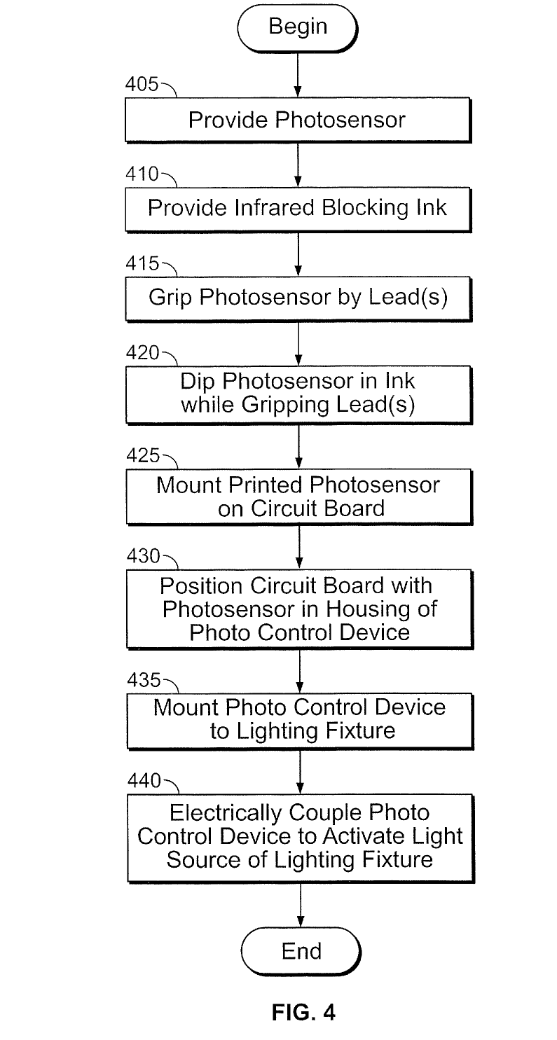

A method of fabricating a photo control device including a filtered photosensor according to some embodiments of the present invention will now be described with reference to the flowchart illustration of FIG. 4. As shown in the embodiments of FIG. 4, operations begin by providing a photosensor (block 405) and an infrared blocking ink (block 410).

Operations at block 405 and 410 may correspond substantially to those described with reference to blocks 310 and 320 of FIG. 3. Operations corresponding to the printing operation of block 330 will now be described with reference to block 415 and 420 of FIG. 4 for particular embodiments using dipping of the photosensor to provide the printing. The photosensor is gripped by lead(s) extending therefrom (block 415). The body of the photosensor is dipped in the infrared blocking ink while gripping the lead(s) to retain the photosensor (block 420).

The printed photosensor is mounted on a circuit board (block 425). The circuit board including the photosensor is positioned in a housing of a photo control device with the photosensor positioned to receive light passing through the housing (block 430). As described with reference to FIG. 2 above, the circuit board may further include a relay that is activated by the photosensor.

In some embodiments of the present invention as illustrated in FIG. 4, operations continue with mounting the photo control device to a lighting fixture (block 435). The photo control device is electrically coupled to a light source of the lighting fixture to control activation of the light source responsive to a level of light detected by the photosensor (block 440).

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

1. A method of forming a filtered photosensor, comprising:
providing a photosensor;
providing an infrared blocking ink; and
printing the infrared blocking ink on the photosensor.

2. The method of claim 1, wherein printing the infrared blocking ink comprises dipping the photosensor in the infrared blocking ink.

3. The method of claim 2, wherein the photosensor includes a body having a lead extending therefrom and wherein dipping the photosensor in the infrared blocking ink includes:
gripping the photosensor by the lead; and
dipping the body of the photosensor in the infrared blocking ink while gripping the lead to retain the photosensor.

4. The method of claim 1, wherein printing the infrared blocking ink comprises spraying and/or brushing the infrared blocking ink on the photosensor.

5. The method of claim 1, wherein the photosensor comprises a photodiode.

6. The method of claim 1, wherein the photosensor comprises a surface mount photosensor and wherein printing the infrared blocking ink comprises spraying the infrared blocking ink on the surface mount photosensor.

7. A method of fabricating a photo control device including a filtered photosensor, comprising:
providing a photosensor;
providing an infrared blocking ink;
printing the infrared blocking ink on the photosensor;
mounting the printed photosensor on a circuit board; and
positioning the circuit board including the photosensor in a housing of the photo control device with the photosensor positioned to receive light passing through the housing, the circuit board further including a relay that is activated by the photosensor.

8. The method of claim 7, wherein printing the infrared blocking ink comprises dipping the photosensor in the infrared blocking ink.

9. The method of claim 8, wherein the photosensor includes a body having a lead extending therefrom and wherein dipping the photosensor in the infrared blocking ink includes:
gripping the photosensor by the lead; and
dipping the body of the photosensor in the infrared blocking ink while gripping the lead to retain the photosensor.

10. The method of claim 7, wherein printing the infrared blocking ink comprises spraying and/or brushing the infrared blocking ink on the photosensor.

11. The method of claim 7, wherein the photosensor comprises a photodiode.

12. The method of claim 7, wherein the photosensor comprises a surface mount photosensor and wherein printing the infrared blocking ink comprises spraying the infrared blocking ink on the surface mount photosensor.

13. The method of claim 7, wherein positioning the circuit board including the photosensor in a housing of the photo control device is followed by:
mounting the photo control device to a lighting fixture; and
electrically coupling the photo control device to a light source of the lighting fixture to control activation of the light source responsive to a level of light detected by the photosensor.

14. A photo control device, comprising:
a housing including a light transmissive portion;
a photosensor positioned in the housing to receive light passing through the light transmissive portion of the housing;
an infrared blocking coating on the photosensor that limits sensitivity of the photosensor to infrared electromagnetic radiation; and
a relay electrically coupled to the photosensor that is responsive to a level of light detected by the photosensor.

15. The photo control device of claim 14, wherein the infrared blocking coating comprises an infrared absorbing ink and wherein the photosensor comprises a phototransistor.

16. The photo control device of claim 15, wherein the light transmissive portion comprises a window in the housing and wherein the photo control device further comprises a circuit board mounted in the housing and wherein the phototransistor and the relay are mounted on the circuit board.

17. The photo control device of claim 16, wherein the photo control device comprises a street lighting photo control device and the relay is configured to activate to switch off street lighting responsive to detection of light by the phototransistor.
